(19) United States
(12) Patent Application Publication
(10) Pub. No.: US 2015/0337974 A1
(43) Pub. Date: Nov. 26, 2015

(54) Inflation valve cap apparatus and method

(71) Applicant: Charles Allen, Hurricane, WV (US)

(72) Inventor: Charles Allen, Hurricane, WV (US)

(21) Appl. No.: 14/122,000

(22) Filed: Nov. 13, 2014

Related U.S. Application Data
(60) Provisional application No. 61/997,173, filed on May 23, 2014.

(51) Int. Cl. F16K 15/20; B65D 77/24

(52) U.S. Cl. CPC F16K 15/205; B65D 77/24

(57) ABSTRACT

An inflation valve cap having a cap body and a valve body for inflating or pressurizing a beverage bottle.

### PRIOR APPLICATION

This application claims the benefit of U.S. Provisional Application No. 61/997,173, filed May 23, 2014, the disclosure of which is hereby incorporated by reference in its entirety.

### FIELD OF THE INVENTION

The present application discloses and describes an inflation valve cap, and in particular, an inflation valve cap for use with a plastic beverage bottle to allow pressurization of the beverage bottle with air for repurposed use thereof.

### BACKGROUND OF THE INVENTION

The National Shooting Sports Foundation (“NSSF”) reports that approximately 20.2 million target shooting enthusiasts spend approximately $493 per person, or $9.9 billion per year in total, on all aspects of target shooting, and inject approximately $23 billion into the national economy. http://www.nssf.org/PDF/research/TargetShootingInAmericaReport.pdf. However, the NSSF also reports that target shooting participation falls off significantly when target ranges are located more than 30 minutes away. This is a particularly acute problem in rural areas where the populations are scattered outside of densely populated areas and away from the economic centers that generally have such target shooting facilities, thereby increasing travel time and costs dedicated to such recreational activities.

In an attempt to counteract these effects, target shooting equipment is available in sporting goods stores that allow enthusiasts to attempt simulation of the shooting range experience. However, expense to the individual enthusiast becomes a concern, especially considering individuals rarely purchase equipment and materials in bulk quantities at discounted rates as is often available to commercial shooting range facilities.

One means of addressing expense is through the adoption of “plinking” in which nonstandard targets are utilized as means for simulating or replicating shooting range targets. Usually, the “target” is an object made from metal, wood, glass, plastic, paper, or other similar material, and is often an object that has been previously damaged, reached a state of obsolescence, or is repurposed for an unintended use. However, certain types of “flat” objects fail to fully replicate the sound and experience one achieves on a range.

Accordingly, there is a need for easily-assembled repurposed objects and materials that may be utilized as “plinking” targets to simulate shooting range targets and conditions that is also cost effective and provides additional modes of feedback to enhance the excitement and fun of target shooting that might not otherwise be attained under similar circumstances.

Accordingly, there is an unresolved need for easily-assembled repurposed objects and materials that may be utilized as “plinking” targets.

### SUMMARY OF THE INVENTION

Example embodiments provide an inflation valve cap having a cap body with an aperture, and a valve body having a bore and perforation, and the aperture, bore, and perforation re arranged in coaxial alignment. The cap body may include a plurality of internal threads for threaded coupling with a threaded beverage bottle neck or throat.

In one embodiment, the valve body includes a flange, a bulb, and a stem intermediately disposed therebetween, the valve body having a bore and a perforation in coaxial alignment, the bore traversing the flange, stem, and a portion of the bulb, and the perforation traversing from the terminus of the bore to the margin of the bulb.

In another embodiment, the valve body includes a flange, a bulb, and a stem, the flange intermediately disposed therebetween, the valve body having a bore and a perforation in coaxial alignment, the bore traversing the flange, stem, and a portion of the bulb, and the perforation traversing from the terminus of the bore to the margin of the bulb.

It is envisioned that another embodiment comprises a method of using an inflation valve cap having a cap body and a valve body, the method comprising the steps of ensuring the valve body is mostly inserted into the throat of a beverage bottle, threading the cap body onto the neck of the beverage bottle, inserting an inflation needle through the cap body and valve body, inflating the beverage bottle to a sufficient air pressure, and removing the inflation needle from the cap body and the valve body. It is further envisioned that an additional step of targeting the beverage bottle with a weapon may be included.

### BRIEF DESCRIPTION OF THE DRAWINGS

FIG. 1 illustrates one embodiment of an inflation valve cap in exploded view for use with a beverage bottle and an inflation device;

FIG. 2 illustrates one embodiment of the cap body and valve body in cut-away;

FIG. 3 illustrates one embodiment of the cap body; and

FIG. 4a illustrates one embodiment of the valve body; and

FIG. 4b illustrates another embodiment of the valve body.

### DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

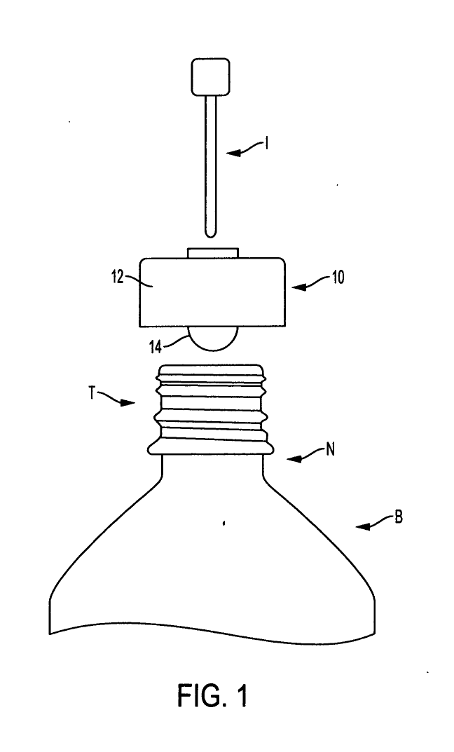

In accordance with the drawings illustrating at least one embodiment of an inflation valve cap for use on a threaded bottle, as generally depicted in FIG. 1 through FIGS. 4a and 4b, an inflation valve cap 10 is depicted as including a cap body 12 and a valve body 14. The cap body 12 houses the valve body 14. The cap body 12 includes an aperture 16 in coaxial alignment with a mutually coaxial bore 18 and perforation 20 disposed within the valve body 14. The cap body 12 includes internal threads for threaded coupling with the threaded neck of a beverage bottle. It is envisioned that all sizes of beverage bottle and cap may be adapted for use in the manner described herein.

The cap body 12 may be constructed from a variety of materials, including many plastics or elastomeric material. It is envisioned that materials presently used in industrial manufacturing of plastic bottle caps will be utilized to take advantage of economies of scale and preexisting technology and techniques. Accordingly, it is envisioned that cap bodies will be manufactured from polyethylene or polypropylene, a thermoplastic material used in the manufacture of plastic containers and bottles. However, other similarly suitable thermoplastic polymers capable of sustaining stretching and blow molding techniques are contemplated as within the scope of the embodiments.

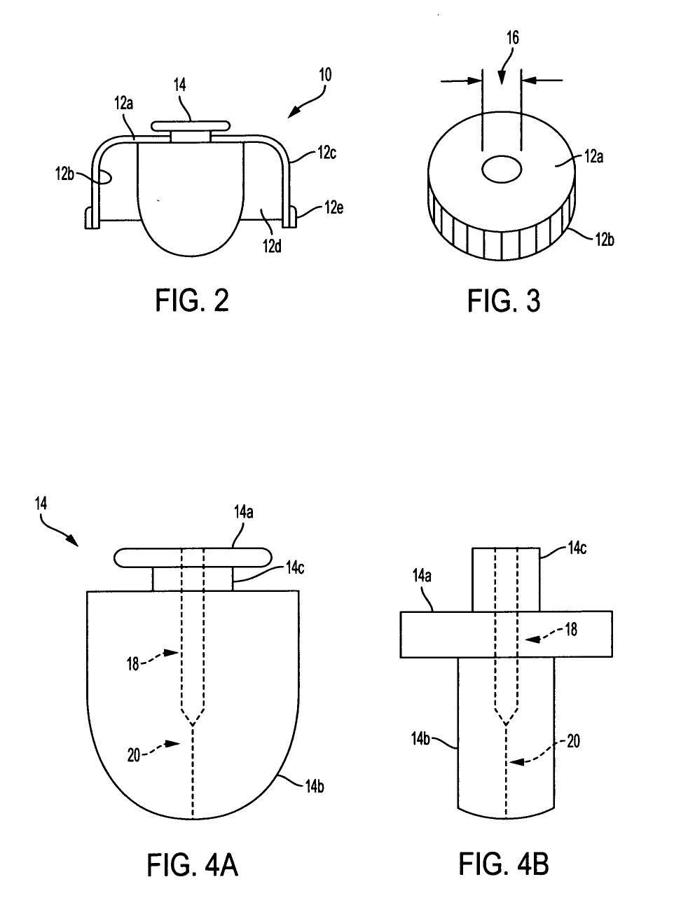

As depicted in FIG. 2 and FIG. 3, the cap body 12 may comprise a wall 12a having a depending wall 12b circumscribing the exterior margin of wall 12a, and thereby forming an outer surface 12c and an inner surface 12d. The wall 12b may be integral and mutually coterminous to wall 12a. The outer surface 12c may comprise a knurled or ridged arrangement providing means for a user to securely grasp and rotate for threading and unthreading the cap body 12 to and from a threaded bottle neck. In one embodiment, the inner surface 12d may comprise multiple threads complementary to the external threads provided on the bottle neck. In another embodiment, it is envisioned that the cap body 12 may be secured by force impingement using a variety of known means, and through the pressurization of the bottle, the cap body 12 will securely hold to the bottle neck. A reinforced skirt 12e may circumscribe the free terminus of wall 12b that opposes the coterminous junction of walls 12a and 12b.

The cap body 12 may comprise an aperture 16 formed through the wall 12a. The aperture 16 may comprise a plurality of dimensions. In particular, the aperture 16 may be generally arranged in coaxial alignment with the bore 18 and perforation 20 formed in the valve body 14, discussed in greater detail below, although precise coaxial alignment is not required, so long as an inflation needle can traverse the aperture 16 and into the bore 18 and perforation 20. The aperture 16 may be formed during the molding process of the cap body 12 or may be formed post-molding. In one embodiment, the aperture 16 may retain the valve body 14, and in particular, may retain the valve body 14 so that a portion of the valve body 14 resides opposite to and concentrically within the inner surface 12d of the cap body 12.

As depicted in FIG. 4a, the valve body 14 may be constructed from a variety of materials, including natural or synthetic rubbers (e.g., polymeric elastomers), so long as the material(s) is/are resilient, flexible, and durable. It is envisioned that one embodiment of the valve body 14 comprises a toroidal or annular flange 14a, a bulbous portion 14b, and an intermediately disposed stem 14c. The bore 18 is concentric to the flange 14a, bulbous 14b, and stem 14c portions, and therefore generally concentric to the valve body 14 as a whole. The bore 18 penetrates or traverses the flange 14a portion and the stem 14c portion, and partially penetrates or traverses the bulbous portion 14b. A perforation 20 begins at the terminus of the bore and continues to the exterior margin of the bulbous portion 14b. The perforation 20 forms a substantially impermeable seal within the valve body 14 so that no appreciable quantity of air, liquid, or other media or material ingresses or egresses the perforation 20. The bore 18 is adapted to receive and retain an inflation needle from a hand pump, pneumatic pump, compressor, or other similar inflation device. The perforation 20 is adapted to displace when the inflation needed is inserted therethrough, and to retain the inflation needle during the inflation process. After the inflation needle is removed from the perforation 20, the material urges return of the perforation to an initial state of being a substantially impermeable barrier, and thereby preventing media ingress or egress across the perforation 20.

In another embodiment, as depicted in FIG. 4b, the valve body 14 comprises a toroidal flange 14a intermediately disposed between a bulbous portion 14b and a stem 14c. The bore 18 is concentric to the bulbous 14b, flange 14a, and stem 14c portions, and therefore generally concentric to the valve body 14 as a whole. The bore 18 penetrates or traverses the flange 14a portion and the stem 14c portion, and partially penetrates or traverses the bulbous portion 14b. A perforation 20 begins at the terminus of the bore 18 and continues to the exterior margin of the bulbous portion 14b.

It is envisioned that the valve body 14 may be integral to the cap body 12 so that a portion of the valve body 14 resides on one side of aperture 16 and another portion of valve body 14 resides on the opposing side of aperture 16. In this arrangement, the valve body 14 may be formed concurrent with or sequentially to the formation of the aperture 16 in cap body 12. In another embodiment, it is envisioned that valve body 14 and cap body 12 are separate components that may be coupled through compression or impingement of the valve body 14 by the cap body 12 (using the threaded coupling of the cap body 12 to the threaded neck of the beverage bottle).

It is envisioned that the inflation valve cap may be sold as a part of a kit. In one embodiment, the kit includes packaging and a plurality of inflation valve caps 10 contained in the packaging. In another embodiment, the kit includes packaging, a plurality of inflation valve caps 10, and instructions for use. In another embodiment, the kit includes packaging, instructions for use, and a plurality of inflation valve caps 10 comprising an integral cap body 12 and valve body 14. In another embodiment, the kit includes packaging, instructions for use, and plurality of inflation valve caps 10 comprising a cap body 12 separate from the valve body 14. In another embodiment, the kit includes packaging, instructions for use, and a plurality of inflation valve caps comprising at least one integral cap body 12 and valve body 14 and at least one separate cap body 12 and one separate valve body 14.

In use, the inflation valve cap 10 may be installed on a plastic beverage bottle (B). Ensuring that the valve body 14 will at least partially reside in the throat (T) of the beverage bottle (B) neck (N), the cap body 12 may be threaded onto the neck (N) of the bottle (B). An inflation needle (I) may be inserted through the aperture 16 (of cap body 12) and through bore 18 and perforation (of valve body 14) so that the terminus of the inflation needle (I) is in fluid communication with the interior volume of the beverage bottle (B). Thereafter, a pump may be used to direct air from the pump, through the needle, and into the interior volume of beverage bottle (B). Once the beverage bottle (B) is sufficiently filled with air, the inflation needle (I) may be removed, thereby sealing the air and any other media within the beverage bottle (B). The beverage bottle (B) may be positioned or staged as desired for target shooting. A weapon may be used to propel a projectile at the beverage bottle (B) target with the intention of rupturing the beverage bottle (B). It is envisioned that a weapon may comprise a variety of articles, including traditional firearms, compressed air or CO₂-powered BB or pellet guns, crossbows, longbows, sling-shots, or other similar articles.

It is envisioned that another useful step includes the addition of water, with or without coloring, to approximately ¼ to ⅓ of the total volume of the beverage bottle (B). Providing a water-based medium allows the user to invert the beverage bottle (B) from its typical orientation, including placement in a base suitable for holding the neck (N) of the beverage bottle (B). In addition, it is believed that the addition of a water-based medium for inverted-staging of the beverage bottle (B) insulates the inflation valve cap 10 from damage and extends the useful life of the cap 10 for additional uses. It is further envisioned that other suitable fluid material may be used to infill the internal volume of the beverage bottle.

It is further envisioned that a powder-media may be used to fill the interior volume of the beverage bottle (B) to safely replicate the shooting range experience. For example, at some shooting ranges, tannerite is used to generate flash explosions and smoke to indicate to a shooter that s/he has hit the target. Tannerite comprises two inert materials that when combined are poised to explode and smoke upon contact by a bullet or round of ammunition. To avoid using potentially explosive materials, and since flat objects do not receive and retain powder easily, the use of powder (e.g., talc) within the interior volume of a beverage bottle (B) provides a safe and fun alternative as a means for indicating the target has been successful struck during target practice.

Although the inflation valve cap 10 has been generally described for recreational use apart from a traditional target shooting range, it is envisioned that a commercial shooting range may use and incorporate such devices, apparatuses, methods, and concepts as well, therefore, all the descriptions and examples should be understood as broadly applying to uses at commercial shooting ranges and off-site on the personal property of target shooting enthusiasts and the like, and unless otherwise stated, no limitation should be interpreted or implied.

For example, a commercial shooting range or a property owner could collect and repurpose commercially sold plastic beverage bottles (B) for targets as generally described above. The ubiquity of 2-liter, 1-liter, 24-, 16-, and 8-ounce bottles, and other such containers, allow the range or owner to mix and match a plurality of variously sized beverage bottles (B) for competition-style course arrangements, since the large bottles will be easier to see and strike and the smaller bottles more challenging. Avoiding redundancy in the type of target utilized for practice is often a key aspect in maintaining the interest of novice target shooters. After the beverage bottles (B) have been struck, the plastic fragments may be collected and shipped to a recycling center, thereby providing the added advantage of recycling such bottles or containers and advancing the recycling step by initially breaking down the bottles into smaller fragments.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations.

Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

1. An inflation valve cap comprising:
a cap body having an aperture; and
a valve body having a bore and perforation; and
the aperture, bore, and perforation arranged in coaxial alignment.

2. The inflation valve cap of claim 1, wherein the cap body further comprises internal threads.

3. The inflation valve cap of claim 1, wherein the bore is adapted to receive an inflation needle.

4. The inflation valve cap of claim 1, wherein the valve body further comprises:
a valve body having a flange, a bulb, and a stem intermediately disposed therebetween, the valve body having a bore and a perforation in coaxial alignment, the bore traversing the flange, stem, and a portion of the bulb, and the perforation traversing from the terminus of the bore to the margin of the bulb.

5. The inflation valve cap of claim 4, the bore and the perforation in fluid communication with the interior volume of a beverage bottle.

6. The inflation valve cap of claim 1, wherein the valve body further comprises:
a valve body having a flange, a bulb, and a stem, the flange intermediately disposed therebetween, the valve body having a bore and a perforation in coaxial alignment, the bore traversing the flange, stem, and a portion of the bulb, and the perforation traversing from the terminus of the bore to the margin of the bulb.

7. The inflation valve cap of claim 6, the bore and the perforation in fluid communication with the interior volume of a beverage bottle.

8. A kit comprising:
a package;
a set of instructions; and
a plurality of inflation valve caps.

9. The kit of claim 9, wherein each one of the inflation valve caps comprises:
a cap body having an aperture; and
a valve body having a bore and perforation; and
the aperture, bore, and perforation arranged in coaxial alignment.

10. The kit of claim 9, wherein the valve body further comprises:
a valve body having a flange, a bulb, and a stern intermediately disposed therebetween, the valve body having a bore and a perforation in coaxial alignment, the bore traversing the flange, stem, and a portion of the bulb, and the perforation traversing from the terminus of the bore to the margin of the bulb.

11. The kit of claim 9, wherein the valve body further comprises:
a valve body having a flange, a bulb, and a stem, the flange intermediately disposed therebetween, the valve body having a bore and a perforation in coaxial alignment, the bore traversing the flange, stem, and a portion of the bulb, and the perforation traversing from the terminus of the bore to the margin of the bulb.

12. A method of using an inflation valve cap having a cap body and a valve body, the method comprising the steps of:
ensuring the valve body is mostly inserted into the throat of a beverage bottle;
threading the cap body onto the neck of the beverage bottle;
inserting an inflation needle through the cap body and valve body;
inflating the beverage bottle to a sufficient air pressure; and
removing the inflation needle from the cap body and the valve body

13. The method of claim 12, further comprising the step of targeting the beverage bottle with a weapon.

14. The method of claim 12, further comprising the step of: adding a fluid material to the beverage bottle.

15. The method of claim 14, wherein the fluid material comprises water.

16. The method of claim 14, wherein the fluid material comprises a non-water material.

17. The method of claim 12, further comprising the step of: adding a powder material to the beverage bottle.
